(19) United States
(12) Patent Application Publication
(10) Pub. No.: US 2018/0178745 A1
(43) Pub. Date: Jun. 28, 2018

(54) METHOD AND DEVICE IN A MOTOR VEHICLE FOR PROTECTING PEDESTRIANS

(71) Applicant: Robert Bosch GmbH, Stuttgart (DE)

(72) Inventor: Johannes Ludwig Foltin, Ditzingen (DE)

(21) Appl. No.: 15/849,871

(22) Filed: Dec. 21, 2017

(30) Foreign Application Priority Data
Dec. 22, 2016 (DE) 102016226040.5

(51) Int. Cl. B60R 21/013; B60R 21/34

(52) U.S. Cl. CPC B60R 21/013; B60R 2021/01204; B60R 21/34

(57) ABSTRACT

A method for adjusting at least one trigger criterion of a protection system for the protection of external road users to be protected, especially preferably for the protection of pedestrians, including specifying the trigger criterion for a standard driving situation, ascertaining a longitudinal velocity of the motor vehicle, ascertaining a current or expected transverse movement of the motor vehicle, calculating at least one detection range of at least one environmental sensor for detecting potential collision objects as a function of the longitudinal velocity and the transverse movement, calculating whether collision objects having a predefinable maximum velocity may be struck by the motor vehicle without having previously been detected in the detection range by the environmental sensor, and modifying the trigger criterion to a modified trigger criterion if collision objects may be struck by the motor vehicle without having previously been detected in the detection range by environmental sensor.

### CROSS REFERENCE

The present application claims the benefit under 35 U.S.C. § 119 of German Patent Application No. DE 102016226040.5 filed on Dec. 22, 2016, which is expressly incorporated herein by reference in its entirety.

### FIELD

The present invention relates to a method for adjusting at least one trigger criterion of a protection system, in particular for protecting external road users to be protected, especially a pedestrian protection system, for use in a motor vehicle. It also relates to a corresponding device for executing the present method.

### BACKGROUND INFORMATION

In the event of an accident of a motor vehicle, reversible and non-reversible restraint systems are meant to protect the driver from serious consequences. Various systems, which may be subdivided into sensors and actuators, are available for mitigating the accident consequences for the driver.

For example, among the actuators of passive safety in the vehicle interior are active seats, belt pretensioners or airbags. There are various developments among airbags, such as a driver airbag of the steering wheel, knee airbags for protecting the knees in a forward displacement and preventing sliding out from under the belt, window airbags for protecting the head in a side impact and for preventing objects from entering the passenger compartment from the outside. Active seats are able to change shape in an accident and thereby prevent sliding out from underneath the belt, or they can bring the driver into a more advantageous position (e.g., moving the seat back so that the driver has more space relative to the steering wheel, thereby allowing for a reduction of the maximum accelerations for the driver). Belt pretensioners reduce what is known as seat-belt slack and couple the driver to the vehicle. This reduces the forward displacement of the driver and/or makes it possible to decelerate the driver more uniformly together with the vehicle.

Collisions of a motor vehicle with a pedestrian are able to be mitigated by raising the engine hood, for example, and/or by additionally igniting external airbags for pedestrians in order to soften the severity of the impact of the pedestrian on structural components of the vehicle, in particular the engine block or the A-pillars.

Various sensors are used for ascertaining an accident and the accident type. The main sensor is usually an acceleration sensor, which is installed in the center of the vehicle in the most protected manner possible. Such a main sensor may suffice for a simple detection of an accident, but it is not as powerful and error-tolerant as a multi-sensor system.

Pedestrian accidents are often detected by mounting additional contact sensors, such as acceleration sensors, in the frontal area of the engine hood of a vehicle so that the weak acceleration values that a pedestrian causes in the vehicle are able to be measured in a timely manner and the accident can be detected without delay.

In addition or as an alternative, it is possible to use a pressure-hose sensor, which is made up of a silicon hose that usually has two pressure sensors at the ends. The hose is installed behind the bumper. When the leg of a pedestrian compresses the bumper, the pressure in the hose rises or a pressure wave is generated in the hose. The sensors detect the pressure increase and are able to use the run-time difference of the pressure wave to determine the impact position of the pedestrian on the vehicle. Acceleration sensors at various locations in the vehicle are able to plausibilize the signal from the pressure sensor. Pressure sensors have the advantage over acceleration sensors that they can respond very quickly, and the pressure hose on the vehicle front has the advantage that it is able to cover a large area using relatively few sensors (two pressure sensors as a rule). The impact point is ascertainable with an accuracy of 5 cm, for example.

Another important group of sensors that are used for detecting possible accident situations in a motor vehicle are what is known as environmental sensors, which ascertain environmental data from the environment of a motor vehicle, monitor the environment of the vehicle in this way, and are used for detecting and classifying possible collision partners.

A device for actuating an actuator system for the protection of pedestrians for a motor vehicle is described in German Patent Application No. DE 103 34 699 A1. In this case, a first signal from a contact sensor system or a threshold for the comparison with a first signal from a contact sensor system is modified as a function of a second signal from an environmental sensor system, and the actuator system is operated as a function of the comparison.

### SUMMARY

In accordance with the present invention, a particularly advantageous method and a particularly advantageous device for adjusting at least one trigger criterion of a protection system for a road user are provided.

Especially advantageous developments of the present invention are described herein.

Active protection systems in motor vehicles (such as an electronic stability control ESP or a brake actuator) and comfort systems (e.g., lane-keeping assistant) are networked to an ever greater extent also with systems of passive safety.

Protection systems in motor vehicles frequently have different functional characteristics for different types of safety-relevant situations to which a motor vehicle may be exposed. Such functional characteristics are a grouping of different safety functions that are triggered in a particular situation. For example, functional characteristics such as “collision case” and “frontal collision”, “side collision”, “pedestrian collision”, etc. often exist. Depending on the functional characteristic, protection systems in a motor vehicle are employed in an adapted form. It is the task of sensors and protection systems to allocate an existing situation to the correct functional characteristic and to select this functional characteristic. It is also possible to select multiple functional characteristics parallel to one another in existing situations.

In the functional characteristic “collision case”, for example, such a system (e.g., an airbag-trigger algorithm) is adjusted on the basis of environmental sensors. Environmental sensors (mono/stereo camera, radar, lidar ultrasound) detect the environment and ascertain a potential imminent collision as well as its collision type. In the event of an imminent collision, an airbag control unit may be adjusted to be more sensitive so that the restraint systems are able to be triggered more rapidly.

A frontal collision with a vehicle is able to be predicted with the aid of a radar sensor and a corresponding functional characteristic thereby be selected. During the predicted instant at which the accident should take place, the activation threshold for restraint systems is reduced (in other words, a more sensitive and earlier reaction) within the scope of this functional characteristic. If the classic sensors of passive safety then register a possible accident, a faster or temporally more selective response is possible because the plausibilization period (the time the system requires to check whether a collision in all likelihood has actually occurred) is able to be limited. Depending on the development stage, a frontal or a side collision is able to be predicted with the aid of radar sensors, or a reaction to a rear collision may also take place. Different accident opponents may be distinguished in the collisions, e.g., a vehicle, truck, pedestrian or a firmly anchored object, and a corresponding functional characteristic be specifically selected in each case.

The functional characteristic “collision case” always requires that an accident has already taken place. Predictively operating systems merely shorten the reaction time, which makes it possible to better prepare the vehicle occupants for the accident (create more space in order to dissipate kinetic energy and thereby avoid acceleration peaks). The basic functionality of collision sensing with the aid of acceleration sensors etc. remains the same. The goal of the functional characteristics “frontal collision” and “side collision” is usually a more rapid triggering of the restraint systems in the vehicle interior. In the functional characteristics of a “pedestrian collision”, on the other hand, it is usually also attempted to make the triggering of the pedestrian protection systems more robust (but certainly with fewer erroneous triggering cases), since the acceleration signal in a collision with a pedestrian is very low and difficult to distinguish from other situations. Simulations use what is known as a “leg impacter” (a special dummy leg), which weighs only approximately 6 kg and must cause a triggering event. A small animal, on the other hand, should not necessarily lead to triggering (bird strike, impact of small animals such as rabbits and the like). Erroneous triggering is undesired because pedestrian protection systems are often configured to be irreversible, and a protection system that is triggered in error causes expense.

Environmental sensors for acquiring environmental data have only a limited detection range or a detection range of a predefined shape. For example, a long-range radar has a detection range of under +/−10°, and a camera has a detection range of +/−25°, for example. The angles mentioned here define a respective conical region in front of the motor vehicle inside of which typical environmental sensors are able to detect objects.

It should be noted that the detection range has a spatial and a temporal component. Along a driven route, an environmental sensor spatially detects all immovable objects across a certain width (which should be greater than the width of the road), the width depending on the particular distance in front of a motor vehicle that the environmental sensor is still able to scan. The situation is different for mobile objects, i.e., especially external road users that may move at a predefinable maximum speed in the direction of the traveled road. Depending on the velocities of the motor vehicle and the road user, the result in the time sequence is a detection range that may possibly take the form of a circle segment and starts at the environmental sensor; outside of this detection range, the road user is able to move without being detected by the environmental sensor. Such a representation is used here in the figures. Due to said temporal component of the detection range, it may happen, for example, that a pedestrian is still outside the maximum width detected by the environmental sensor when the motor vehicle is far away, but later comes closer and closer to the road and even collides with the motor vehicle without ending up in the detection range, which increasingly narrows in the course of time, at the respective location of the pedestrian.

Objects that are located along the sides beyond the detection range are unable to be detected. Since an opening angle is involved, a segment of space is measured for which the sensor represents the point at which the detection range has its origin. The covered width is near zero at this point (when disregarding the blind range in front of the sensor). The detection of objects requires a certain amount of time. In order to make the detection robust with respect to noise, the system often accepts only the objects that were visible for a particular amount of time.

Acceleration sensors, whose task consists of measuring a pedestrian impact, are connected to the vehicle body. Driving through a pothole may therefore generate a signal that is identical in its magnitude to a signal caused by a pedestrian being struck by a car because acceleration sensors supply only limited information (measuring channels) in comparison with environmental sensors (such as a video sensor equal to 1,000,000 measuring points or pixels).

Functional characteristics for pedestrian protection or “pedestrian collision” should provide high robustness in order to ensure the most optimal protection possible for pedestrians. It is for this reason, for example, that the threshold for triggering the pedestrian protection is raised (i.e., is made less sensitive) when no pedestrian or no potential pedestrian has been detected by the environmental sensor. Conversely, the threshold is lowered if a pedestrian has been detected. The problem in this context is the opening angle of the environmental sensor: in the near range, where the accident takes place, the width covered by the sensor is very small (opening angle, origin in the sensor).

The article by S. N. Huang, J. K. Yang and F. Eklund “Analysis of Car-Pedestrian Impact Scenarios for the Evaluation of a Pedestrian Sensor System Based on the Accident Data from Sweden”, describes basic situations for potential collisions of pedestrians and vehicles; it also describes sensor systems for vehicles for detecting such situations.

The processes and systems illustrated herein for pedestrians are also transferrable, with certain restrictions, to other road users who should be protected and are located outside of the vehicle, such as children at play, bicyclists, wheelchair riders or the like. For this reason, the following text sometimes also mentions collision objects or road users that should be protected. The measures described here, in particular in the context of protecting external road users, in certain cases are also transferrable to other protection functions, such as the protection of occupants of the motor vehicle.

In the triggering of pedestrian protection systems, it is often possible to mitigate the consequences for the pedestrian in the event of a collision between a pedestrian and a motor vehicle. Possible as protection systems are pedestrian airbags, for example, or the raising of the engine hood. In most systems, the triggering has the result that the vehicle is unable to continue its travel and that irreversible systems must first be replaced, which costs money.

Therefore, it is desirable that pedestrian-protection systems be triggered in error only rarely if no actual collision with a pedestrian has actually taken place. Depending on the complexity of a pedestrian protection system, erroneous triggering may have many causes, e.g., uneven road surfaces, collisions with small animals, falling rocks and objects located in a traffic lane.

Advanced assistance systems for motor vehicles are therefore configured to identify pedestrians in the environment of the motor vehicle already prior to a collision, if possible, with the aid of suitable sensors, to predict potential collisions, e.g., based on the relative velocity between pedestrian and vehicle, and to prevent them to the greatest extent possible or to mitigate the consequences for the pedestrian by the timely triggering of pedestrian protection systems when an impact is detected. Incorrect triggering is unlikely in such cases.

Conversely, this means, however, that delayed triggering or even erroneous triggering in a detected impact is more likely if no pedestrian was previously identified on the collision course. Such cases are the focus of the present method. Particular attention is paid to situations in which the vehicle is not only driving straight ahead at a longitudinal velocity but also executes a transverse movement, in particular passes through at least one curve and/or drifts toward the side. In these cases, the vehicle has a longitudinal velocity and executes a transverse movement that is generally able to be characterized by a curve radius, a steering angle, or a transverse velocity or transverse acceleration.

While the vehicle is driving straight ahead, the scanning of the environment, especially the environment in front of the vehicle (as described in the article cited earlier), is relatively simple and results in simple physical correlations as to when and at what relative velocities an identified pedestrian may potentially collide with the vehicle, and where the collision point is located. The situation is different during cornering. As will be described in greater detail in the following text, in a cornering situation it is more likely that a pedestrian will not be able to be detected and identified, or will not be able to be detected and identified in a reliable manner, by at least one environmental sensor of the motor vehicle although the pedestrian and the vehicle are on a potential collision course. Although an impact will then be registered by sensor systems of the motor vehicle, it cannot be connected to a pedestrian who was already previously identified, as would be the case during straight-ahead driving.

Straight-ahead driving, in which sensitivity criteria featuring certain conditions and threshold values may be predefined for the triggering of (external) protection systems, is considered the standard driving situation here. Since a particular protection system can only be triggered or not be triggered, and the precise instant of the triggering is additionally able to be determined, a criterion must ultimately be specified that, when encountered, results in a triggering. In general, a protection system processes different information from different sensors, so that the trigger criterion may include the simultaneous presence of multiple items of information, possibly also with different weightings. Erroneous triggering may largely be avoided here in that the environmental data from environmental sensors and data from impact sensors are checked for plausibility, so that triggering takes place only when the impact of a pedestrian seems to be indicated with sufficient probability. The method described here also encompasses the protection of pedestrians during cornering and other transverse movements of a vehicle.

This is based on the understanding that environmental sensors of a motor vehicle are typically developed such that they detect a region in front of a driving vehicle that is of sufficient width for recognizing road users who could collide with the motor vehicle (assuming they do not change their speed or movement direction). It is therefore possible to require the simultaneous presence of two conditions as a trigger criterion for pedestrian protection measures, e.g., “a pedestrian on a collision course was detected with the aid of at least one environmental sensor or environmental data”, and “the impact of an object was detected by the contact sensor”. In practice, a probability (weighting) may additionally be allocated to the conditions, and a certain minimum probability (threshold value) for the existence of an impact of a road user may be employed as a trigger criterion. In this context, it is especially the amount that environmental data or environmental sensors are still able to contribute to the monitoring of the environment in front of the motor vehicle during a cornering operation. For this purpose, the present method utilizes the data pertaining to the longitudinal velocity of the motor vehicle and the transverse movement in order to determine which sections of the environment located in front of the vehicle while passing through one or more curves were not detected to such a degree that the presence of collision objects could be ruled out. External road users (pedestrians, bicyclists, running children) with their typical minimum speeds may cross the road specified by the motor vehicle and be struck by the motor vehicle without ever having made it into the detection range of the environmental sensor(s). Thus, if the calculation of the detection range indicates the presence of such a situation, then the trigger criterion will be modified in the described method, in particular insofar as the triggering of the protection system in a standard situation no longer requires that all the conditions be met. The advantage of such a modification of the trigger criterion is that protection measures are also initiated when only the impact of an object is detected but no prior identification of a potential collision object has taken place. Although it is then no longer fully possible, the way it is in straight-ahead travel, to avoid erroneous triggering caused by falling rocks or a pothole, for example, the safety of pedestrians is increased instead, which is important, especially during cornering and in particular at intersections in an inner-city environment.

The trigger criterion for a standard driving situation specified in step a), for example, is a trigger criterion that is defined for conventional straight-ahead driving in the absence of a transverse acceleration.

The ascertaining of the longitudinal velocity and the transverse movement in steps b) and c) in particular means that signals pertaining to the longitudinal velocity and the transverse movement ascertained by sensors are received. However, it is also possible that calculations by which the longitudinal velocity and the transverse movement are calculated from other measured quantities are carried out within the framework of ascertaining the longitudinal velocity and the transverse movement.

The calculation in step d) preferably takes place in a device for executing the described method.

Maximum velocities that are taken into account in step e) may be stored as permanently stored parameters in a control unit. Depending on the traffic situation, it is also possible to store other maximum velocities for possible road users or also for collision objects. For example, for a traffic situation in the city, a maximum velocity may be specified on the basis of the maximally possible speed of a running person (e.g., between 20 km/h and 25 km/h). Other maximum velocities may be stored in rural areas (for instance between 25 km/h and 60 km/h) in an effort to also reliably include faster road users such as riders of two-wheeled vehicles. In steps e) and f), calculations or a change in a trigger criterion take(s) place as a function of whether collision objects did not enter a detection range of the motor vehicle or entered it only for a very short penetration phase. If no collision objects have entered the detection range, then it makes sense that they could not be classified. On the other hand, a classification may perhaps have been impossible also if the penetration phase was very short, such as shorter than a threshold period, for instance.

In one preferred specific embodiment of the present method, the measured longitudinal velocity as well as a steering angle of the motor vehicle are taken into account when ascertaining the transverse movement of the motor vehicle. If predictive driver assistance systems are involved, it is even possible to predict upcoming cornering on the basis of the existing data pertaining to the street layout and to start the calculation of the detection range. For example, it is also possible to utilize the operation of the turn signal indicator in a predictive manner for triggering the calculation of the detection range in an expected transverse movement. All of these measures may help in providing the respective current detection range for the protection system.

In one preferred specific embodiment of the present method, the trigger criterion in a standard driving situation includes at least two different conditions for detecting an external road user to be protected, in particular a pedestrian; however, the modified trigger criterion includes at least one less condition or a condition that is given a lower weighting. As already described, especially the condition “road user on a collision course was detected” may be dispensed with during cornering, so that the trigger criterion is now based only on the information from the remaining sensor systems. In principle, it is possible to omit a condition not completely but to take it into account only at a lower weighting. For example, this makes it possible to consider the actual cornering situation, so that different weighting is used in the case of a large curve radius than in a turning maneuver in inner-city traffic, for example.

In one special embodiment of the present method, the trigger criterion in a standard driving situation includes the condition that, prior to a collision, the protection system has identified an external road user to be protected as a collision object, in particular a pedestrian, with the aid of the environmental sensor, but this condition is not required during cornering or is weighted to a lesser degree.

It is also possible to use two or more environmental sensors within the scope of the present invention, and/or to carry out a separate analysis of two or more detection ranges of an environmental sensor within the scope of the present method. In one special embodiment, the described method allows for a subdivision of the environment into two or more detection ranges in such cases. Here, the conditions for detecting a collision object as a road user to be protected, in particular a pedestrian, may be selected differently and/or be weighted differently for the different detection ranges. This allows for an even better adaptation of the protection system to different traffic situations. This is especially useful because there are no symmetrical conditions relative to the environment in front of the vehicle during right-hand or left-hand driving.

In one preferred specific embodiment, the motor vehicle is equipped with one or more contact sensor(s) by which a location of contact on the motor vehicle is able to be ascertained. In other words, not only the fact of a collision is determined but also the approximate location of the impact on the front of the motor vehicle. In the method described here, at least one main contact area together with an area width and an area position in which contact with a road user to be protected is unable to take place without a prior detection by the environmental sensor in the detection range is now ascertained as a function of the longitudinal velocity and the transverse movement of the motor vehicle. This is done in such a way that the trigger criterion for a standard driving situation is maintained for this main contact area despite a transverse movement. Road users that the environmental sensor has failed to detect may typically end up only in the edge regions of the vehicle front due to their low speed in relation to the motor vehicle, because they would otherwise be first encountered in the detection range of the environmental sensor. For this reason, it can be excluded as a highly unlikely possibility that a road user that had previously not been located in the detection range will be encountered there in a main contact area.

In one special development of the present method, the main contact area is adapted in its area width and/or its area location as a function of the longitudinal velocity and the transverse movement of the motor vehicle. This means that the area width will be reduced in the case of tighter curves and/or a higher velocity, for example. Due to the geometrical conditions of an environmental sensor during cornering, a shift of the main contact area away from the center of the front and towards the side lying opposite from the cornering direction is also a useful measure for simultaneously ensuring the protection of the road user and reducing the likelihood of an erroneous triggering. Just on their own, these measures for adapting the area width and and/or the area location of the main contact area already represent a preferred application form of the present method that allows for an adaptation of the trigger criterion of a protection system even if the detection range of the environmental sensor has only been very roughly calculated.

In the embodiments up to this point it was assumed that the longitudinal velocity and also the transverse velocity of the motor vehicle are constant, at least in sub-sections of the travel distance. In a non-constant longitudinal velocity and transverse velocity, the geometrical relationships and the resulting calculations of the detection range and potential collision locations become somewhat more complicated. However, this does not represent a fundamental problem because, for example, the velocities are able to be integrated over time or a correction of the detection range may be made when one of the velocities changes. As far as accelerations or decelerations in the longitudinal or transverse direction are concerned, when a maximum protection of road users to be protected is endeavored, it is generally advantageous to base any further measures on the smallest detection range resulting from the arising velocities.

In addition to the previously described systems for detecting a transverse movement of the motor vehicle, one preferred embodiment of the present method utilizes at least one acceleration sensor, which ascertains the transverse acceleration of the motor vehicle. This method is very precise for controlled cornering and provides the exact transverse movement of the motor vehicle with the aid of simple sensors.

Also described is a device for adjusting at least one trigger criterion of a protection system for external road users, in particular a pedestrian protection system, for a motor vehicle.

The device is suitable for executing the afore-described method and serves as a reliable protection of external road users even during cornering of a motor vehicle. The device increases the protection for external road users during cornering without raising the risk of erroneous triggering operations to any significant degree.

The device is a control unit, in particular, which is developed to execute the described method.

More specifically, the means for ascertaining a longitudinal velocity and a transverse movement are also connections of the control unit at which signals pertaining to the longitudinal velocity and the transverse movement may be received. However, corresponding sensors for measuring the longitudinal velocity and the transverse movement or variables from which they are able to be calculated may also be included in this context.

The device is especially preferred if it also includes means for determining a contact between the motor vehicle and a collision object as well as a trigger for pedestrian protection measures upon the detection of a contact at the contact sensor as a function of the modified trigger criterion. Means for determining a contact, for example, may be inputs for signals regarding contact of the motor vehicle with a collision object, and/or sensors for detecting such a contact.

A computer program, which is designed to execute the described method will also be described here, as will a machine-readable memory medium on which this computer program is stored.

Details of the present method and exemplary embodiments are described in greater detail in the following text with the aid of the figures.

### BRIEF DESCRIPTION OF THE DRAWINGS

FIG. 1 shows schematically, a motor vehicle and its environment during cornering.

FIG. 2 shows the front region of a motor vehicle shortly before the collision with a pedestrian, in a schematized representation.

FIG. 3 shows a schematized flow diagram to illustrate the sequences in the described method.

### DETAILED DESCRIPTION OF EXAMPLE EMBODIMENTS

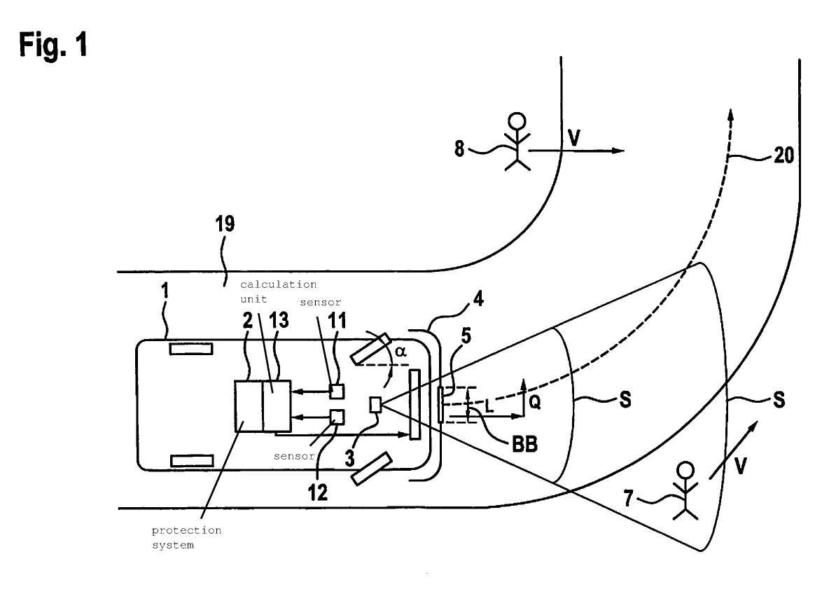

FIG. 1 shows a motor vehicle 1 on a curved road 19 with a potential driving trajectory 20. Motor vehicle 1 has a protection system 2 for external road users 7 to be protected, who are moving at a predefinable maximum speed V. Using an environmental sensor 3, motor vehicle 1 scans the environment in a detection range S that essentially has the form of a circle segment. In addition, motor vehicle 1 includes a contact sensor (which may also be composed of a plurality of individual sensors) by which the fact of a collision with a pedestrian and also the approximate location of impact are able to be determined. Contact sensor 4 is allocated a main contact area 5 whose area width BB and area position BL in the front area of motor vehicle 1 are able to be designed to be dependent upon the traffic situation. Protection system 2 has a calculation unit 13, which is connected to a first sensor 11 and a second sensor 12. First sensor 11 provides information about longitudinal velocity L of motor vehicle 1, while second sensor 12 provides information pertaining to a transverse movement Q. Transverse movement Q, for example, may depend on a steering angle a (alpha) or also on a drift movement of motor vehicle 1. In the event of a collision with an external road user 7 to be protected, motor vehicle 1 has at least one protection component 6. The triggering of protection component 6 is meant to mitigate the consequences of a collision for road user 7. FIG. 1 shows that external road users 7 to be protected are able to be identified and tracked by detection range S of environmental sensor 3 even during cornering. However, depending on the trajectory of a cornering operation, this does not apply to all potential collision objects 8, in this instance, also to a pedestrian who is intent on crossing road 19. There is the risk that collision object 8 will be struck by motor vehicle 1 in the further course of driving without collision object 8 even having previously appeared in detection range S at all, or without having been in it long enough to allow for a correct identification. It is especially for situations such as this that the protection system is to be configured as a secure and robust system.

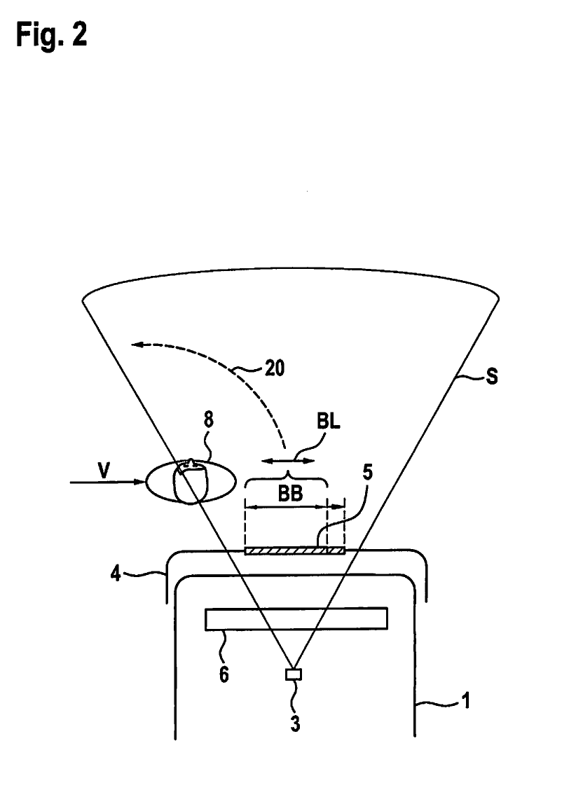

FIG. 2 shows a constellation as it may result in a continued movement of motor vehicle 1 along driving trajectory 20 and collision object 8. Shown is the enlarged frontal region of motor vehicle 1 together with contact sensor 4 and its main contact area 5. In this particular instance, collision object 8 is depicted as a pedestrian who is moving at a maximum speed V and is shown shortly before the collision with motor vehicle 1. Main contact area 5 is set to a relatively narrow area width BB due to the cornering operation of motor vehicle 1, and, as indicated by a dashed line, may also be asymmetrically situated on the vehicle front, especially shifted counter to the direction of the curve. Such an area location BL takes the fact into account that in a left curve, objects on the right side of the road are able to be detected much easier and earlier than those on the left side. Collision object 8 will strike contact sensor 4 outside of main contact area 5 without having previously been identified by the environmental sensor. For this reason, it is advantageous for the protection of this collision object 8 if protection component 6 is triggered as soon as contact sensor 4 responds and also without an identification as a pedestrian having previously been made by environmental sensor 3. If collision object 8 had been a little faster or motor vehicle 1 somewhat slower, then its presence in detection range

S would have been of sufficient length for an identification and the collision would take place in main contact area 5. In this case, too, protection component 6 would be triggered, but only if a contact with main contact area 5 and an identification as a pedestrian by environmental sensor 3 would have occurred at the same time. However, if a stone or a small animal were to strike main contact area 5 in such a situation, then protection component 6 would not be triggered because no previous identification as a pedestrian has taken place.

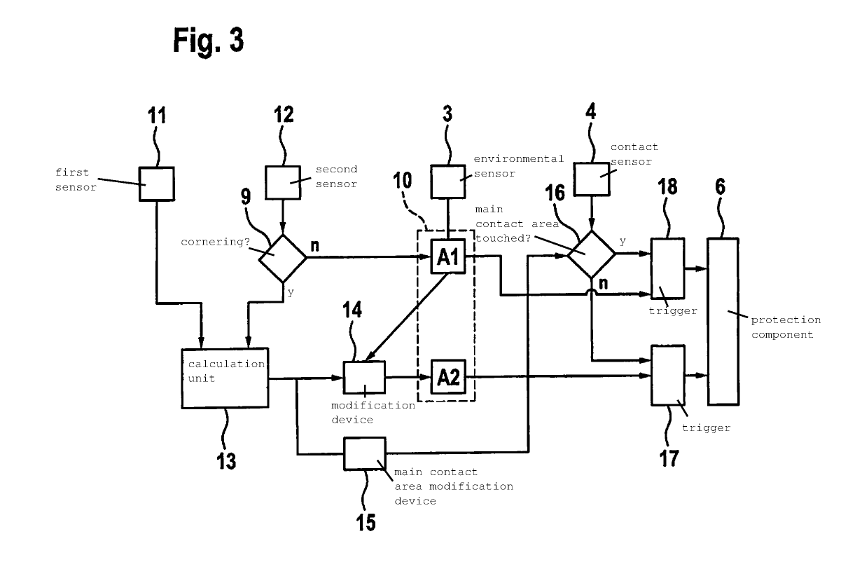

FIG. 3 shows the sequence of the method in protection system 2 in a schematized representation. Data pertaining to longitudinal velocity L of a motor vehicle 1 are supplied to a calculation unit 13 with the aid of a first sensor 11. A second sensor 12 supplies data regarding a transverse movement Q of motor vehicle 1, i.e., initially to a query 9 regarding cornering. If cornering is taking place, then the data are forwarded to calculation unit 13. If no cornering is present, then a trigger criterion A1 for a standard driving situation in a memory medium 10 remains relevant. If cornering is occurring, then calculation unit 13 calculates a current detection range S of environmental sensor 3 and triggers device 14 to modify trigger criterion A1 to a modified trigger criterion A2. Modified trigger criterion A2, too, is able to be stored in memory medium 10. If a collision triggers a signal from contact sensor 4, then there are two possibilities, depending on whether or not the detected contact lies in main contact area 5. A query 16 to main contact area 5 is carried out for this purpose. In the system selected as an example in this instance, area width BB and area location BL of main contact region 5 are specified by a device 15 for modifying main contact area 5, which in turn is actuated by calculation unit 13 as a function of the curve situation. If no cornering is present, then main contact area 5 typically extends across entire contact sensor 4. In the case of a tight curve, area width BB is very small and area location BL may possibly be shifted out of the center of the vehicle front and counter to the curve direction. If query 16 determines that main contact area 5 has been touched, then protection component 6 is triggered via triggering 18 according to trigger criterion A1 for a standard driving situation, both in the case of cornering and straight-ahead driving. If main contact area 5 is not touched, on the other hand, then the triggering of protection component 6 takes place according to modified trigger criterion A2 via triggering 17 for cornering. In other words, triggering takes place even if no pedestrian has been identified by environmental sensor 3.

Because of the described protection system, external road users to be protected are protected by suitable trigger criteria even in the event of a collision during cornering without significantly increasing the risk of erroneous triggering operations of protection components.

What is claimed is:

1. A method for adjusting at least one trigger criterion of a protection system the protection of an external road user to be protected in a motor vehicle that includes at least one environmental sensor, the method comprising:
a) specifying the trigger criterion for a standard driving situation;
b) ascertaining a longitudinal velocity of the motor vehicle;
c) ascertaining one of a current or an expected transverse movement of the motor vehicle;
d) calculating at least one detection range of at least one environmental sensor for detecting potential collision objects as a function of the longitudinal velocity and the transverse movement;
e) calculating whether collision objects having a predefinable maximum velocity may be struck by the motor vehicle without having previously been detected in the detection range by the environmental sensor; and
f) modifying the trigger criterion to a modified trigger criterion when step e) indicates that collision objects may be struck by the motor vehicle without having previously been detected in the detection range by the environmental sensor.

2. The method as recited in claim 1, wherein the external road user is a pedestrian.

3. The method as recited in claim 1, wherein for the ascertainment of the transverse movement in step c), at least the longitudinal velocity ascertained in step b) and a steering angle of the motor vehicle are taken into account.

4. The method as recited in claim 1, wherein the trigger criterion in a standard driving situation in step a) encompasses at least two different conditions for detecting a road user to be protected, but the modified trigger criterion has at least one less condition or a condition that is weighted to a lesser degree.

5. The method as recited in claim 1, wherein the trigger criterion in a standard driving situation in step a) encompasses a condition that, prior to a collision, the protection system has identified a road user to be protected, as a collision object with the aid of the environmental sensor, and the condition is not weighted or is weighted to a lesser degree after a modification of the trigger criterion in step f).

6. The method as recited in claim 1, wherein an environment in front of the motor vehicle is subdivided into at least two different detection ranges in step f), and the conditions for detecting a collision object as a road user to be protected is at least one of selected and weighted differently for the different detection ranges.

7. The method as recited in claim 1, wherein the following steps are executed after step f):
g) receiving a signal from a contact sensor with regard to a contact of the motor vehicle with a collision object with the aid of at least one contact sensor; and
h) outputting a signal for initiating protection measures according to the modified trigger criterion.

8. The method as recited in claim 7, wherein the at least one contact sensor is able to ascertain a location of contact on the motor vehicle, and at least one main contact area having an area width and an area location, in which contact with a road user to be protected is unable to take place without a prior detection by the environmental sensor in the detection range, is ascertained as a function of the longitudinal velocity and the transverse movement of the motor vehicle, so that the trigger criterion for a standard driving situation is maintained for this main contact region despite a transverse movement.

9. The method as recited in claim 8, wherein the main contact area is adapted in at least one of its area width and its area location, as a function of the longitudinal velocity and the transverse movement of the motor vehicle.

10. The method as recited in claim 1, wherein in step c), at least one transverse acceleration of the motor vehicle, detected using at least one acceleration sensor, is taken into account for ascertaining the transverse movement.

11. A device for adjusting at least one trigger criterion of a protection system for external road users for a motor vehicle, the device comprising:
a memory medium for the trigger criterion for a standard driving situation;
at least one sensor for ascertaining a longitudinal velocity of the motor vehicle;
at least one sensor for ascertaining a current or expected transverse movement of the motor vehicle;
a calculation unit for calculating a detection range of at least one environmental sensor for detecting potential collision objects as a function of the longitudinal velocity and the transverse movement, and for calculating whether collision objects having a predefinable maximum velocity may be struck by the motor vehicle without having previously been detected in the detection range by the environmental sensor; and
a device to modify the trigger criterion to a modified trigger criterion as a function of the result of the calculation in step d).

12. The device as recited in claim 11, wherein the protection system is a pedestrian protection system.

13. A non-transitory machine-readable memory medium on which is stored a computer program for adjusting at least one trigger criterion of a protection system the protection of an external road user to be protected in a motor vehicle that includes at least one environmental sensor, the computer program, when executed by a computer, causing the computer to perform:
a) specifying the trigger criterion for a standard driving situation;
b) ascertaining a longitudinal velocity of the motor vehicle;
c) ascertaining one of a current or an expected transverse movement of the motor vehicle;
d) calculating at least one detection range of at least one environmental sensor for detecting potential collision objects as a function of the longitudinal velocity and the transverse movement;
e) calculating whether collision objects having a predefinable maximum velocity may be struck by the motor vehicle without having previously been detected in the detection range by the environmental sensor; and
f) modifying the trigger criterion to a modified trigger criterion when step e) indicates that collision objects may be struck by the motor vehicle without having previously been detected in the detection range by the environmental sensor.
